(19) United States
(12) Patent Application Publication
(10) Pub. No.: US 2008/0184850 A1
(43) Pub. Date: Aug. 7, 2008

(54) CONTAINMENT SLEEVE FOR DRIVE SOCKETS

(75) Inventors: Patrick S. Livingston, Easton, PA (US); David R. Hicks, Bethlehem, PA (US)

Correspondence Address: MICHAEL BEST & FRIEDRICH LLP, 100 E WISCONSIN AVENUE, Suite 3300, MILWAUKEE, WI, 53202, US

(73) Assignee: INGERSOLL-RAND COMPANY, Montvale, NJ (US)

(21) Appl. No.: 11/672,117

(22) Filed: Feb. 7, 2007

(51) Int. Cl. B25B 13/06

(52) U.S. Cl. 81/121.1; 81/180.1; 81/488

(57) ABSTRACT

A device containing fragments of a failed high torque device such as hydraulic torque device, geared air driven torque machine or impact wrench. The device is a sleeve formed of a woven or web-like material that is positioned around at least a driving or socket end of the high torque device. The sleeve absorbs the impact of fragments upon failure of the high torque device, preventing the fragments from becoming airborne. The sleeve may be assembled with the high torque device during construction of the high torque device, or may be added to the high torque device at a later time. The sleeve may be retro-fit onto the high torque device. The sleeve may be pre-molded, shrink-fit, hot-dipped, slid, rolled or woven onto the high torque device.

### FIELD

The present invention relates to protective sleeves for drive sockets.

### BACKGROUND

Drive sockets for use in high torque applications have improved material and heat treat characteristics. These improvements allow them to be used in conjunction with various device to achieve high torques on fasteners. Such devices include hydraulic torque devices, geared air driven torque machines and pneumatic or electric impact wrenches.

Despite the improved strength of the socket material of these drive sockets, the sockets can still fail due to overload or fatigue conditions. Under certain conditions, fragments of the failed socket can be projected away from the work piece, making them difficult to retrieve.

### SUMMARY

In one embodiment, the invention provides a device for containing fragments of a failed high torque device having a socket end and a handle end. The device includes a sleeve sized and shaped to fit over a socket end of a high torque device. The sleeve is formed of a woven or web-like material.

In another embodiment the invention provides a torque device including a driving end, a driven end, and a sleeve sized and shaped to fit over the driving end. The sleeve is formed of a woven or web-like material.

In yet another embodiment, the invention provides a method of installing a device for containing fragments of a failed high torque device. A high torque device is constructed having a driving end and a driven end. A sleeve formed of a woven or web-like material is formed over at least the driving end of the high torque device.

Other aspects of the invention will become apparent by consideration of the detailed description and accompanying drawings.

### BRIEF DESCRIPTION OF THE DRAWINGS

FIG. 1 is a side view of a high torque device having a socket for use with embodiments of the present invention.

FIG. 2 is a side view of a containment sleeve according to one embodiment of the invention.

FIG. 3 is a side view of a containment sleeve according to another embodiment of the invention.

FIG. 4 is a side view of a containment sleeve according to another embodiment of the present invention.

FIG. 5 is a side view of a containment sleeve assembled with the high torque device of FIG. 1.

FIG. 6 is a perspective view of the assembly of FIG. 5 after socket failure.

FIG. 7 is an end view of the assembly of FIG. 6.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

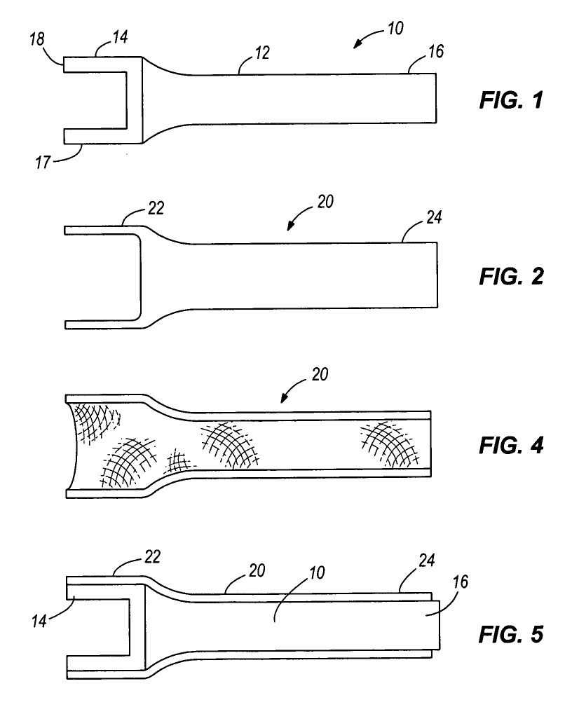

FIG. 1 illustrates a high torque device 10 for use in applying high torque to a fastener. The high torque device 10 can have an elongated body 12 with a driving or socket end 14 and a driven or handle end 16. The socket end 14 of the high torque device 10 may be coupled to a nut or bolt or other fastener to be torqued. The driven or handle end 16 may be coupled to a torquing device such as an air motor (not shown) for torquing the driving end 14 of the high torque device 10.

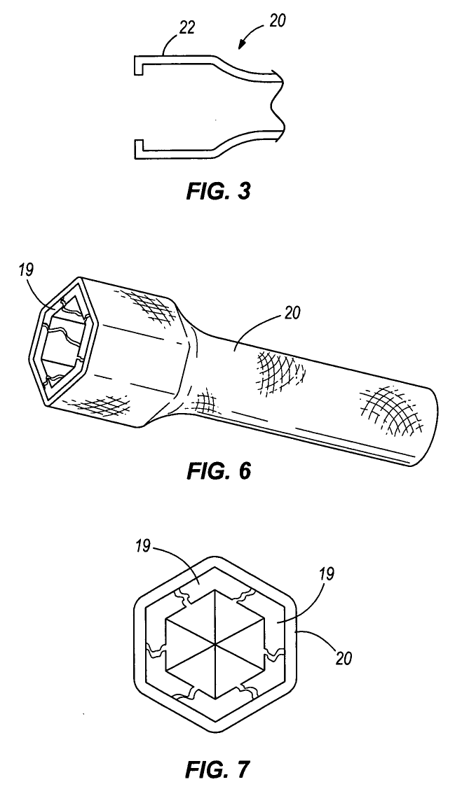

FIG. 2 illustrates a containment jacket or sleeve 20 according to an embodiment of the invention for use with the high torque device 10 of FIG. 1. The containment sleeve 20 can be sized and shaped to fit snugly over the high torque device 10. The containment sleeve 20 can have a socket portion 22 sized to fit over the socket end 14 of the high torque device 10 and a handle portion 24 sized to fit over the handle end 16 of the high torque device 10. In other embodiments, however, the containment sleeve 20 can be shaped to fit over only those portions of the high torque device 10 that are prone to failure. In some embodiments, therefore, the containment sleeve 20 can have the socket portion 22 but lack the handle portion 24 (not shown). In the illustrated embodiment, the containment sleeve 20 is sized and shaped to fit over a side surface 17 of the high torque device 10. In other embodiments, however, the containment sleeve 20 can be sized and shaped to also cover an end surface 18 of the high torque device 10, as illustrated in FIG. 3.

The containment sleeve 20 can be formed of any of a variety of materials that can absorb the impact of a fragment of the high torque device during failure without allowing the fragment to become airborne. The containment sleeve 20 can be made of, for example, a plastic, an elastomer or a spring steel.

FIG. 4 shows a containment sleeve 20 according to another embodiment of the invention, in which the containment sleeve 20 can be formed of a woven-, web-, or mesh-like material. Such materials can absorb the impact of a fragment of the high torque device 10 during failure without allowing the fragment to become airborne. The containment sleeve 20 can be formed of, for example, a wire mesh or a woven fiber.

The containment sleeve 20 can be transparent or semi-transparent. This can allow visual inspection of at least the socket end 14 of the high torque device 10 through the containment sleeve 20 after the containment sleeve 20 has been fit onto the high torque device 10. Examples of transparent or semi-transparent material include but are not limited to transparent or semi-transparent plastics or elastomers and woven-, web-, or mesh-like material in which the pattern and/or the density of the weave (or web or mesh) can permit the high torque device 10 to be viewed therethrough.

The containment sleeve 10 can be installed on the high torque device 10 according to a variety of methods. In general, the containment sleeve 10 can be (1) installed on the high torque device 10 as the high torque device 10 is being constructed, or (2) installed on the high torque device 10 after the high torque device 10 has been constructed. In the latter method especially, the containment sleeve 20 can be added onto or retro-fit onto existing high torque devices 10. The method by which the containment sleeve 10 is actually installed on the high torque device 10 depends largely on the material and construction of the containment sleeve 20 itself. The containment sleeve 20 can be pre-molded onto the high torque device 10, shrink-fit over the high torque device 10, or applied to the high torque device 10 by a hot-dip process. In other embodiments, the containment sleeve 20 can be slid over or rolled onto the high torque device 10. In still other embodiments, the containment sleeve 20 can be woven onto the high torque device 10.

FIG. 5 shows the containment sleeve 20 assembled with or installed onto the high torque device 10 of FIG. 1. FIGS. 6 and 7 illustrate the high torque device 10 and containment sleeve 20 after failure of the high torque device 10. The socket end 14 of the high torque device 10 has splintered, forming fragments 19. The containment sleeve 20 has absorbed the force of the fragments upon failure. Therefore, the fragments 19, rather than becoming airborne upon failure, are retained within the containment sleeve 20. In the illustrated embodiment, the containment sleeve 20 is at least semi-transparent, as previously discussed. The fragments 19 are visible through the containment sleeve 20, allowing a user to visually inspect the high torque device 10 and observe fragmentation and failure of the high torque device 10.

The containment sleeve 20 of FIGS. 2-7 is sized and shaped to fit over the high torque device 10 of FIG. 1. The high torque device 10 of FIG. 1, however, is merely exemplary of high torque devices. Other types of high torque devices include hydraulic torque devices, geared air driven torque machines and pneumatic and electric impact wrenches. It will be appreciated, then, that a containment sleeve in accordance with the invention can be sized and shaped to fit over a variety of high torque devices. Furthermore, any type of drive socket can be subject to failure. Therefore, the invention is not limited to applications involving high torque devices, but rather encompasses any type of drive socket.

Thus, the invention provides, among other things, a device for containing fragments of a failed high torque device that is prone to fragmentation upon failure. Various features and advantages of the invention are set forth in the following claims.

What is claimed is:

1. A device for containing fragments of a failed high torque device having a socket end and a handle end, the device comprising:
a sleeve sized and shaped to fit over a socket end of a high torque device, the sleeve being formed of a woven or web-like material.

2. The device of claim 1, wherein the sleeve has a handle portion sized and shaped to fit over a handle end of the high torque device.

3. The device of claim 1, wherein the sleeve is formed of a wire mesh.

4. The device of claim 1, wherein the sleeve is formed of a plastic or an elastomer.

5. The device of claim 1, wherein the sleeve is semi-transparent.

6. The device of claim 1, wherein the sleeve is sized and shaped to cover a side surface of the high torque device.

7. The device of claim 1, wherein the sleeve is sized and shaped to cover an end surface of the high torque device.

8. The device of claim 1, wherein the sleeve is sized and shaped to fit over one of a hydraulic torque device, a geared air driven torque machine, or an impact wrench.

9. A torque device comprising:
a driving end;
a driven end; and
a sleeve sized and shaped to fit over the driving end, the sleeve being formed of a woven or web-like material.

10. The torque device of claim 9, wherein the torque device is one of a hydraulic torque device, a geared air driven torque machine, or an impact wrench.

11. The torque device of claim 9, wherein the sleeve is semi-transparent.

12. The torque device of claim 9, wherein the sleeve is sized and shaped to cover a side surface of the driving end.

13. The torque device of claim 9, wherein the sleeve is sized and shaped to cover an end surface of the driving end.

14. The torque device of claim 9, wherein the sleeve is formed of a wire mesh.

15. The torque device of claim 9, wherein the sleeve is formed of a plastic or an elastomer.

16. A method of installing a device for containing fragments of a failed high torque device, the method comprising:
constructing a high torque device having a driving end and a driven end; and
forming a sleeve over at least the driving end of the high torque device, the sleeve being formed of a woven or web-like material.

17. The method of claim 16, wherein the sleeve is formed over the high torque device as the high torque device is being constructed.

18. The method of claim 16, wherein the sleeve is formed over the high torque device after the high torque device has been constructed.

19. The method of claim 16, wherein constructing the high torque device further comprises constructing one of a hydraulic torque device, a geared air driven torque machine, or an impact wrench.

20. The method of claim 16, wherein forming the sleeve over at least the driving end of the high torque device further comprises one of pre-molding the sleeve onto the high torque device, shrink-fitting the sleeve over the high torque device, sliding the sleeve over the high torque device, rolling the sleeve onto the high torque device or weaving sleeve onto the high torque device.
